(19) United States
(12) Patent Application Publication
(10) Pub. No.: US 2026/0178335 A1
(43) Pub. Date: Jun. 25, 2026

(54) COMMON INDIRECT ADDRESSING FOR EARLY JUMP EXECUTION PIPELINE CLEAR

(71) Applicant: Intel Corporation, Santa Clara, CA (US)

(72) Inventors: Baishik Biswas, Bangalore (IN); Anant Vithal Nori, Bangalore (IN); Sreenivas Subramoney, Bangalore (IN)

(73) Assignee: Intel Corporation, Santa Clara, CA (US)

(21) Appl. No.: 18/988,026

(22) Filed: Dec. 19, 2024

(51) Int. Cl. G06F 9/38

(52) U.S. Cl. CPC G06F 9/3806; G06F 9/3861

(57) ABSTRACT

Techniques for common indirect addressing for early jump execution pipeline clear are described. In an embodiment, an apparatus includes address calculation circuitry to calculate a displacement value corresponding to a first relative indirect call; a cache to store an entry corresponding to the first relative indirect call, the entry to include the displacement value and a common indirect addressing target; and branch prediction circuitry to provide a branch prediction target for a second relative indirect call, wherein the branch prediction target is to be replaced with the common indirect addressing target.

### BACKGROUND

A processing core in an information processing system may include a branch predictor to keep execution units fed by predicting the outcome of branches in instruction streams.

### BRIEF DESCRIPTION OF DRAWINGS

Various examples in accordance with the present disclosure will be described with reference to the drawings, in which:

FIGS. 1A, 1B, and 1C show examples of code to illustrate runtime polymorphism as a basis for embodiments to improve performance.

FIG. 2 illustrates an apparatus for common indirect addressing for early jump execution pipeline clear according to an embodiment.

FIG. 3 illustrates a method for common indirect addressing for early jump execution pipeline clear according to an embodiment.

FIG. 4 illustrates an example computing system according to an embodiment.

FIG. 5 illustrates a block diagram of an example processor and/or System on a Chip (SoC) that may have one or more cores and an integrated memory controller according to an embodiment.

FIG. 6A is a block diagram illustrating both an example in-order pipeline and an example register renaming, out-of-order issue/execution pipeline according to an embodiment.

FIG. 6B is a block diagram illustrating both an example in-order architecture core and an example register renaming, out-of-order issue/execution architecture core to be included in a processor according to an embodiment.

FIG. 7 illustrates examples of execution unit(s) circuitry according to an embodiment.

FIG. 8 illustrates the use of a software instruction converter to convert binary instructions in a source instruction set architecture to binary instructions in a target instruction set architecture according to an embodiment.

### DETAILED DESCRIPTION

The present disclosure relates to methods, apparatus, systems, and non-transitory computer-readable storage media for common indirect addressing for early jump execution pipeline clear. According to some examples, an apparatus includes address calculation circuitry to calculate a displacement value corresponding to a first relative indirect call; a cache to store an entry corresponding to the first relative indirect call, the entry to include the displacement value and a common indirect addressing target; and branch prediction circuitry to provide a branch prediction target for a second relative indirect call, wherein the branch prediction target is to be replaced with the common indirect addressing target.

Embodiments may provide improved performance in computers and other data and information processing systems by achieving, particularly on workloads with high indirect misprediction rates and/or high code footprints (e.g., games), higher instructions per cycle (IPC) for a small cost in hardware, die area, and power consumption (e.g., better than 1:1 ratio of increase in IPC to increase in Cdyn (dynamic capacitance)). Embodiments may provide improved accuracy of predicting the correct address for cold indirect calls, thus achieving a significant reduction in indirect call misprediction.

As mentioned in the background section, a processor, processor core, execution core, etc. (any of which may be referred to as a core) may include a branch predictor, branch prediction circuitry, branch prediction unit, etc. (any of which may be referred to as a BPU), which may predict the outcome of branches to keep execution units fed according to a technique that may include deep run-ahead into predicted branches. However, branch mispredictions may decrease performance and the cost of the decrease may depend on the type of branch instruction. For example, mispredictions on unconditional direct branches may be fixed relatively early by clearing a branch address pipeline (which may be referred to as a BAClear), whereas mispredictions on a conditional branch or an indirect branch may trigger a significantly more costly clearing of a jump execution pipeline (which may be referred to as a JEClear), which may have a greater and/or more direct impact on performance. The penalty for indirect call mispredictions may be particularly costly in terms of cycles since they may include loading indirect call targets from memory. Moreover, with large code workloads, indirect target prediction may be limited by storage capacity.

Therefore, a common indirect addressing for early jump execution pipeline clear capability that may be provided by embodiments may be desired. For example, embodiments may provide for reducing the target address mispredictions for a set of indirect calls and may also provide for predicting the target addresses of cold indirect calls that were never seen before. For example, embodiments may provide for efficiently predicting the targets of relative instruction pointer (RIP) relative indirect calls such as “call *0x3ddfc(%rip)” where the call target is read from memory and the memory address of the call target is expressed relative to the IP of the call instruction. Embodiments may be based on the observation that polymorphism in code often causes function calls that can be resolved only at runtime, resulting in multiple accesses to the same virtual table function, such that hardware may be used to predict, with high confidence, the target of such indirect calls by analyzing the instruction and target of previous indirect calls. Thus, the use of embodiments may provide higher accuracy in predicting indirect call targets compared to other branch prediction techniques (e.g., global history based branch predictors such as tagged geometric history length branch predictor (TAGE)).

For example, targets of indirect calls may not always be random and may be predicted based on high-level code semantics because polymorphism in modern software may result in a predictable mechanism to generate call targets, as further described below. A feature of polymorphism is to override base class methods with derived class methods. A common use case is to use a base class pointer to point to the derived class object, resulting in function calls whose targets are not known at compile time and can only be resolved at run-time. To execute such calls, a compiler may leave hints in the form of virtual tables (vtable) which hold the address of the correct function to call. Access to the virtual table and subsequent call target computation results may be through a RIP relative indirect calls.

The same vtable function may be called from multiple different places, which results in different RIP relative indirect calls but all having same target. Therefore, embodiments may predict the target of such indirect calls with high confidence. Unlike a TAGE predictor which relies on global branch history, embodiments may follow a simpler approach; for example, by computing a ‘displacement’ for the indirect call instruction pointer (IP) and learning the mapping of displacements with the actual targets.

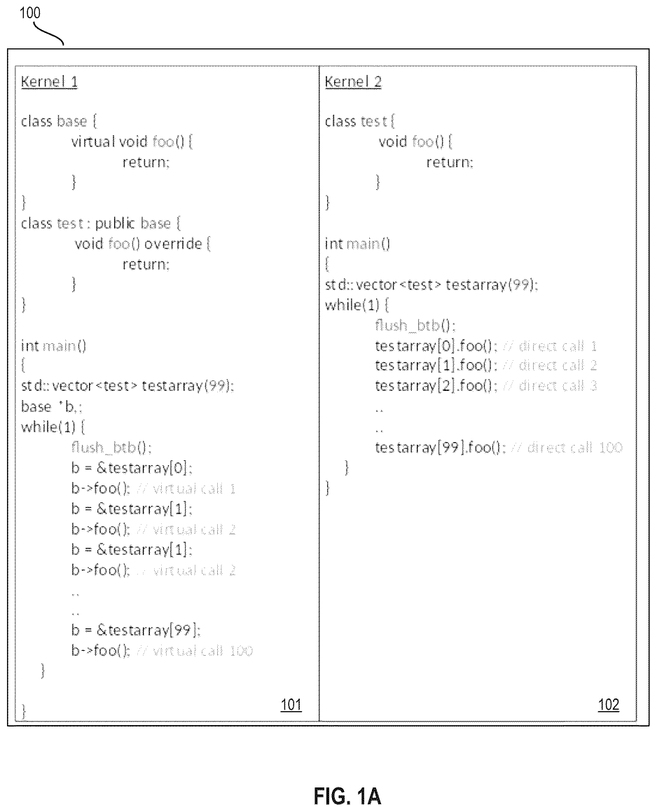

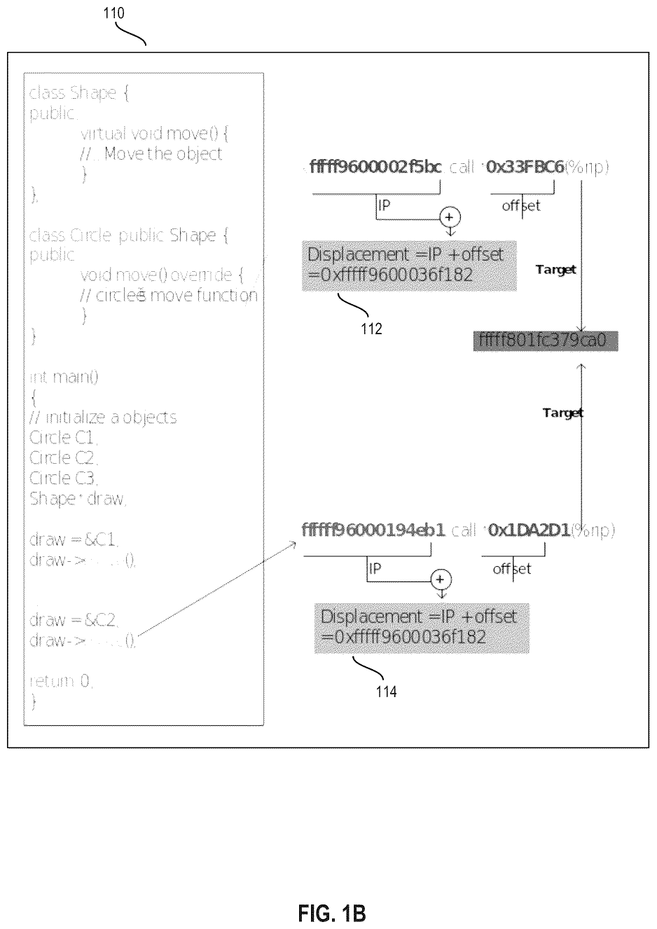

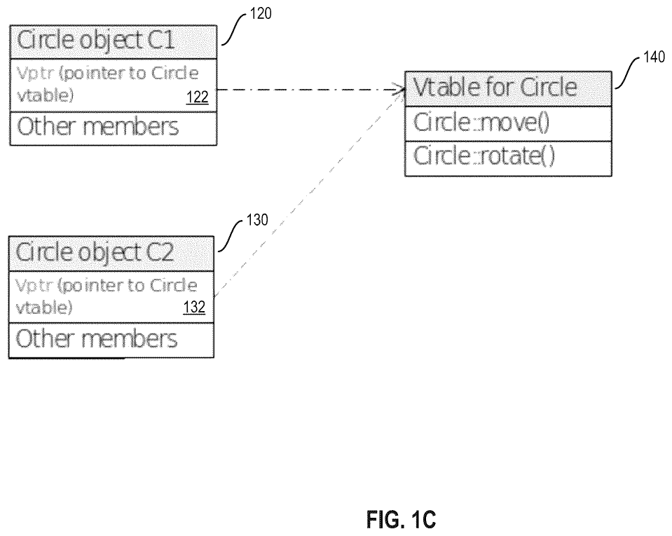

For example, FIG. 1A shows an example of kernel code 100 with virtual function calls that get resolved only at run-time, i.e., enforcing vtable access by having a derived class and a base class.

As shown in kernel 1 (shown as 101) of FIG. 1A, the derived class functions are called via the base class pointers. In contrast, kernel 2 (shown as 102) does not use virtual functions, so it is known at compile time which calls to execute and hence, can use direct calls. A direct call results in a BAClear on misprediction, which have significantly lower misprediction penalty than a JEClear.

In FIG. 1A, the function flush_btb( ) is a standard function that flushes the branch table buffer (BTB), i.e., overwrites the BTB with dummy branch information. For example, the following command in linux flushes the BTB:
echo 3>/proc/sys/vm/drop_caches

The purpose of flushing the BTB is to make the function call as one touch. From the perspective of the BPU and BTB, all function calls in both kernel 1 and kernel 2 are cold, i.e., seen for the first time. Since the function calls are cold, it is not possible for TAGE or other history-based predictor to predict the target address.

When the kernels are run, the runtime of the kernel will be as follows:
In a system including an embodiment, the runtime for kernel 1 will be the

same as kernel 2 because all functions in kernel 1 are cold calls that are dynamically resolved at runtime. Embodiments provide for learning from the first virtual call instruction and accurately predicting the target for the rest of the calls. A BAClear may be generated for the indirect calls instead of a JEClear. History based predictors cannot do that since the calls are one touch, i.e., they have no history.
In contrast, in a system not including an embodiment, kernel 1 will be significantly slower than kernel 2. The virtual calls are resolved dynamically only at execution (generating a JEClear), whereas direct calls in kernel 2 are resolved much earlier in the decode stage (generating a BAClear).

As mentioned above, polymorphism in code often causes function calls that can be resolved only at runtime (e.g., RIP relative indirect calls), resulting in multiple accesses to the same virtual table function, as illustrated in FIG. 1B. FIG. 1B shows an example of code 110 in which class ‘Circle’ is derived from base class ‘Shape’. The function move( ) in class Circle overrides the base class implementation of move( ). Now, the base class pointer draw points to derived class objects C1 and C2. The essence of polymorphism is that when draw->move( ) is called, Circle's move( ) function should be called instead of the base class's move( ). This is achieved in two steps.

First, the compiler creates a vtable for Circle class that holds the address for Circle's move function. It creates a pointer to the vtable and adds it to the objects C1 and C2 (shown as 120 and 130, respectively, in FIG. 1C, an example of a vtable (shown as 140) layout in memory)) which is called vptr (shown as 122 and 132, respectively). At runtime it is not explicitly known which function to call. To solve that, the compiler creates a reference to the vptr of the object (in this case vptr is saved in the memory location of objects C1 and C2 as shown in FIG. 1C).

Second, once vptr is known, the compiler generates code that looks up the vtable, i.e., loads the contents of the vtable, to figure out the IP of the function to be called. Lastly, once the function's IP is known, compiler creates a call instruction.

For example, in the x86 instruction set architecture, the above steps can be efficiently expressed as a single RIP relative call instruction, e.g., ‘call *0x1ffe6(%rip)’. Moreover, having RIP calls allows the compiler to generate position independent code which is more robust.

In embodiments, a new parameter for RIP relative indirect calls may be defined. For example, a new parameter called displacement or call displacement may be the sum of the call's IP and the offset relative to the IP, shown for example as 112 and 114 in FIG. 1B. Calls that have the same target, i.e., access the same vtable function, have the same displacement. Therefore, embodiments may include hardware that learns the displacement and target relations of the indirect calls in order to predict future indirect calls.

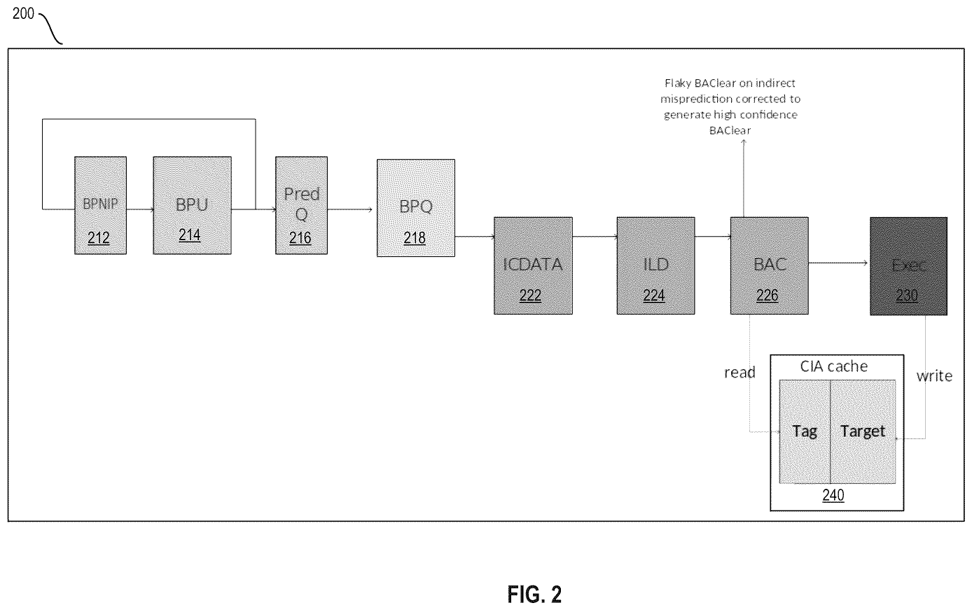

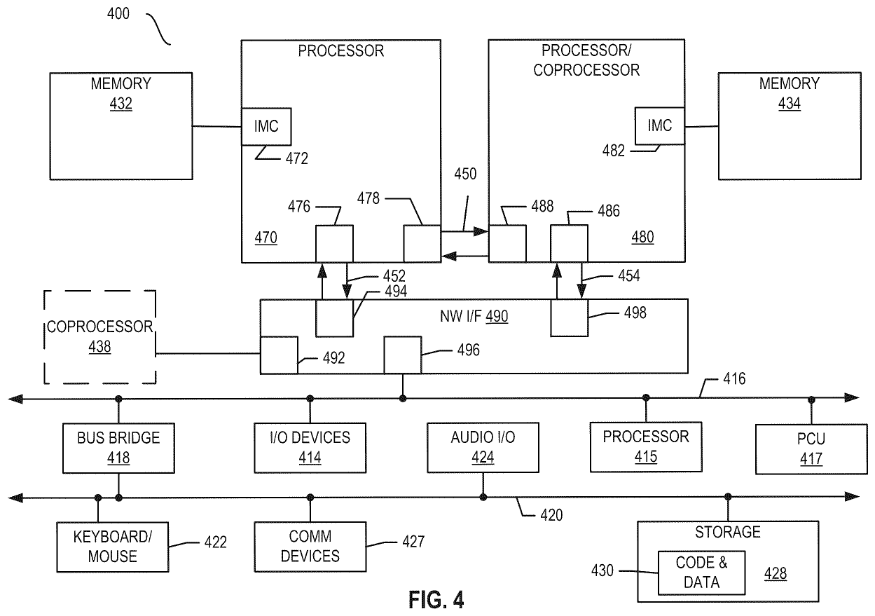

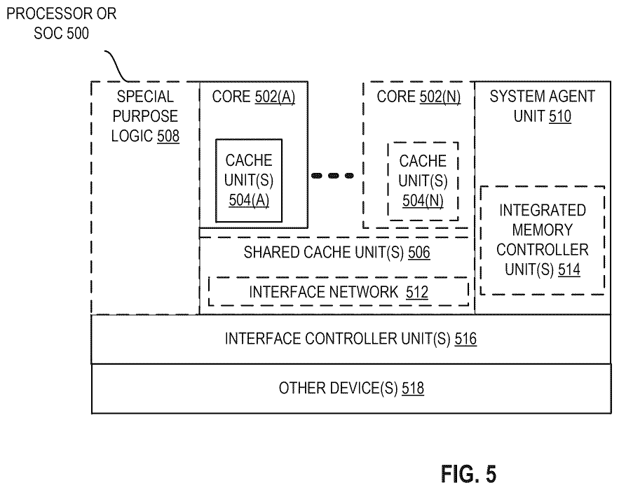

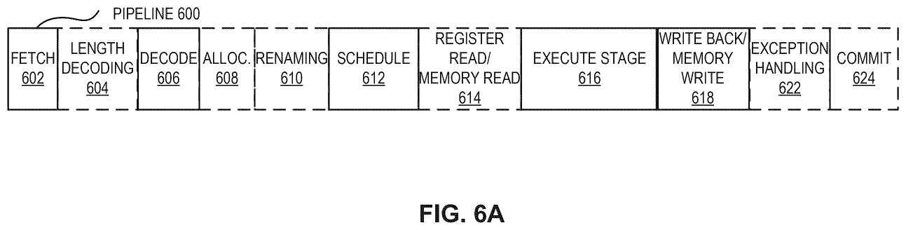

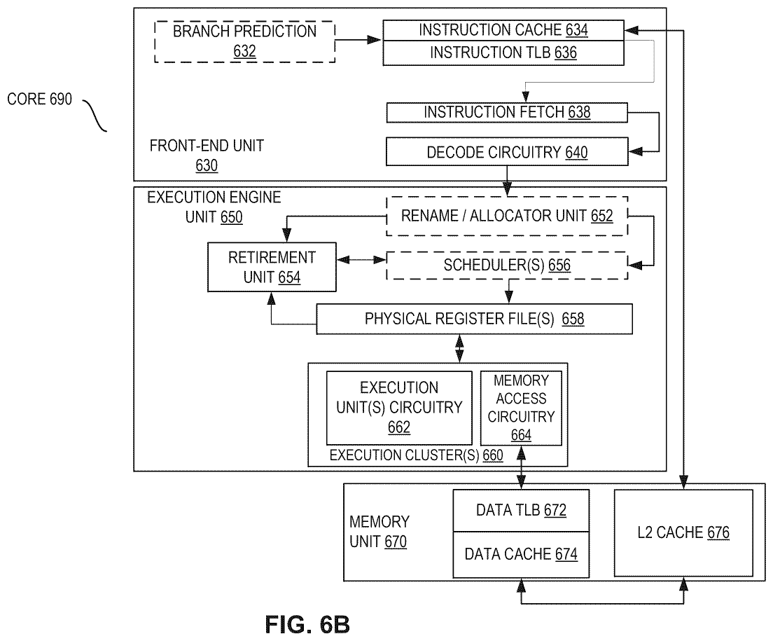

For example, FIG. 2 illustrates an apparatus 200 according to an embodiment. Apparatus 200 represents a portion of a version of an instruction processing pipeline that may be implemented in a processor, processor core, execution core, etc. which may be any type of processor/core, including a general-purpose microprocessor/core, such as a processor/core in the Intel® Core® Processor Family or other processor family from Intel® Corporation or another company, a special purpose processor or microcontroller, or any other device or component in an information processing system in which an embodiment may be implemented. For example, apparatus 200 may be implemented in any of processors 470, 480, or 415 in FIG. 4, processor or system-on-a-chip (SoC) 500 or one of cores 502A to 502N in FIG. 5, and/or core 690 in FIG. 6B, each as described below.

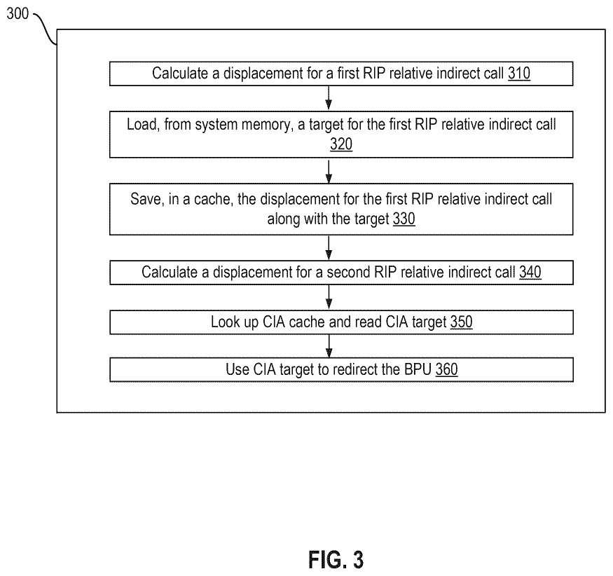

As shown in FIG. 2, apparatus 200 includes circuitry, logic gates, structures, hardware, etc. arranged into pipeline stages branch predictor next instruction pointer (BPNIP) 212, branch prediction unit (BPU) 214, prediction queue (Pred Q) 216, branch prediction queue (BPQ) 218, instruction cache data (ICDATA) 222, instruction length decode (ILD) 224, branch address calculation (BAC) 226, and execution unit (Exec) 230, as may be further described below in connection with the description of FIG. 3. The pipeline stages are shown in FIG. 2 as an example and each may represent any number of stages that may or may not be rearranged and/or overlap with any other stages shown or not shown. Furthermore, any circuitry, logic gates, structures, hardware, etc. shown within a stage in FIG. 2 may be implemented, partially or wholly, within a different stage.

Indirect branches detected at the BA Clear (BAC) stage 226 are looked up in the BPU on a misprediction. If the BPU fails to provide a confident prediction, the result may be a flaky (i.e., potentially inaccurate) BAClear which causes the BPU to stall until the mispredicted branch gets resolved by execution. Embodiments may provide accurate targets for a significant fraction of such flaky BAClears. Thus, a flaky BAClear may be converted to a regular BAClear, instead of having to wait for the actual JEClear, in essence an early JEClear.

FIG. 3 illustrates a method 300 for common indirect addressing for early jump execution pipeline clear according to an embodiment.

In 310, the displacement (IP+offset) of a first RIP relative indirect call is calculated, for example by address calculation circuitry in BAC stage 226.

In 320, a target for first RIP relative indirect call is loaded from a system memory.

In 330 of method 300, at branch execution in execution (Exec) stage 230, the displacement for the first RIP relative indirect call is saved along with the target in a cache. For example, this cache, referred to as a common indirect address (CIA) cache and shown as 240 in FIG. 2, may be indexed and tagged with the displacement value. Embodiments may include a CIA cache with any number (e.g., 32) of entries (e.g., 32).

In 340, in BAClear (BAC) stage 226, the displacement of a second RIP relative indirect call is calculated.

In 350, the CIA cache is looked up and the CIA target is read from the CIA cache, instead of loading a target from memory.

In 360, if the BPU could not provide a confident prediction (e.g., the BPU mispredicted or the call IP is missing in both the TAGE tables and in the BTB), the CIA target is used to redirect the BPU just like a BAClear.

### Example Apparatuses, Methods, Etc.

According to some examples, an apparatus (e.g., a hardware processor, processor core, execution core, etc.) includes address calculation circuitry to calculate a displacement value corresponding to a first relative indirect call; a cache to store an entry corresponding to the first relative indirect call, the entry to include the displacement value and a common indirect addressing target; and branch prediction circuitry to provide a branch prediction target for a second relative indirect call, wherein the branch prediction target is to be replaced with the common indirect addressing target.

Any such examples may include any or any combination of the following aspects. The displacement value is based on an instruction pointer (IP) and an offset corresponding to the first relative indirect call. The displacement value is a sum of the IP and the offset corresponding to the first relative indirect call. Use of the common indirect addressing target results in clearing branch address pipeline circuitry. The branch prediction target is inaccurate. Use of the common indirect addressing target results in clearing branch address pipeline circuitry instead of clearing jump execution pipeline circuitry.

According to some examples, a method includes calculating a displacement value corresponding to a first relative indirect call; storing a cache entry corresponding to the first relative indirect call, the cache entry to include the displacement value and a common indirect addressing target; and replacing a branch prediction target for a second relative indirect call with the common indirect addressing target.

Any such examples may include any or any combination of the following aspects. The displacement value is based on an instruction pointer (IP) and an offset corresponding to the first relative indirect call. The displacement value is a sum of the IP and the offset corresponding to the first relative indirect call. The method includes clearing branch address pipeline circuitry in response to replacing the branch prediction target with the common indirect addressing target. The branch prediction target is inaccurate. Clearing the branch address pipeline circuitry prevents clearing jump execution pipeline circuitry. The method includes loading the common indirect addressing target from a system memory for the first relative indirect call. The method of includes reading the common indirect addressing target from the cache entry for the second relative indirect call instead of loading the common indirect addressing target from the system memory.

According to some examples, a system includes a system memory; address calculation circuitry to calculate a displacement value corresponding to a first relative indirect call; a cache to store an entry corresponding to the first relative indirect call, the entry to include the displacement value and a common indirect addressing target; and branch prediction circuitry to provide a branch prediction target for a second relative indirect call, wherein the branch prediction target is to be replaced with the common indirect addressing target.

Any such examples may include any or any combination of the following aspects. The common indirect addressing target is to be loaded from the system memory for the first relative indirect call. The common indirect addressing target is to be read from the entry for the second relative indirect call instead of loaded from the system memory. The displacement value is based on an instruction pointer and an offset corresponding to the first relative indirect call. Use of the common indirect addressing target results in clearing branch address pipeline circuitry. Use of the common indirect addressing target results in clearing branch address pipeline circuitry instead of clearing jump execution pipeline circuitry.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when decoded and/or executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors'local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2(L2 ), level 3(L3 ), level 4(L4 ), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3(L3 ) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

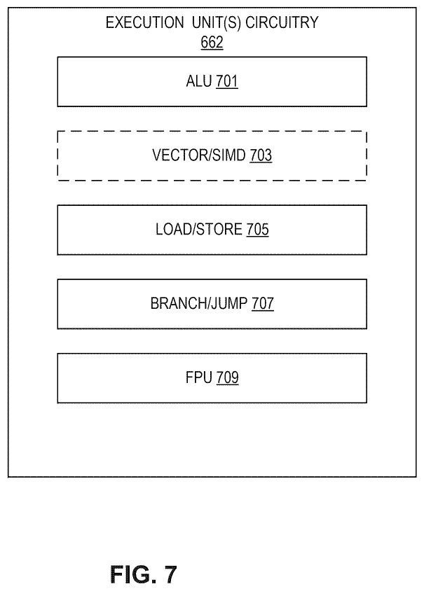

FIG. 7 illustrates examples of execution unit(s) circuitry, such as execution unit(s) circuitry 662 of FIG. 6B. As illustrated, execution unit(s) circuity 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

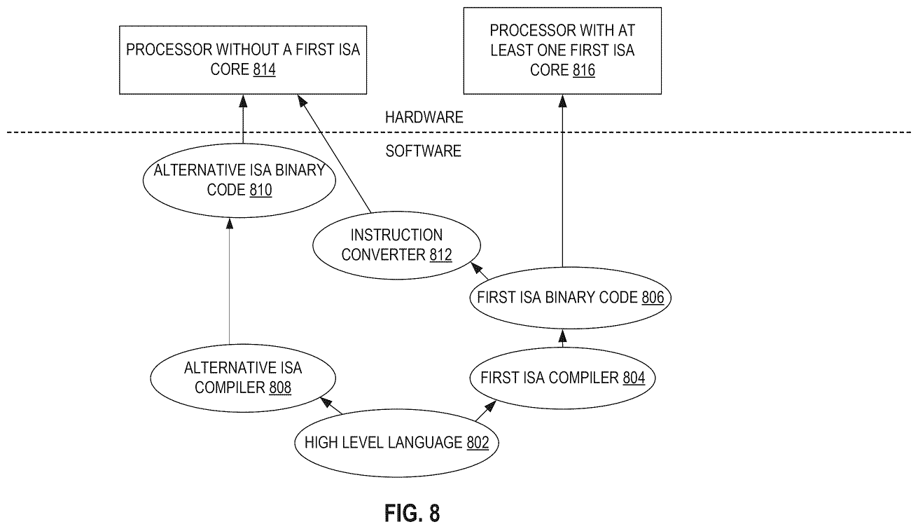

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
address calculation circuitry to calculate a displacement value corresponding to a first relative indirect call;
a cache to store an entry corresponding to the first relative indirect call, the entry to include the displacement value and a common indirect addressing target; and
branch prediction circuitry to provide a branch prediction target for a second relative indirect call, wherein the branch prediction target is to be replaced with the common indirect addressing target.

2. The apparatus of claim 1, wherein the displacement value is based on an instruction pointer (IP) and an offset corresponding to the first relative indirect call.

3. The apparatus of claim 2, wherein the displacement value is a sum of the IP and the offset corresponding to the first relative indirect call.

4. The apparatus of claim 1, wherein use of the common indirect addressing target results in clearing branch address pipeline circuitry.

5. The apparatus of claim 4, wherein the branch prediction target is inaccurate.

6. The apparatus of claim 5, wherein use of the common indirect addressing target results in clearing branch address pipeline circuitry instead of clearing jump execution pipeline circuitry.

7. A method comprising:
calculating a displacement value corresponding to a first relative indirect call;
storing a cache entry corresponding to the first relative indirect call, the cache entry to include the displacement value and a common indirect addressing target; and
replacing a branch prediction target for a second relative indirect call with the common indirect addressing target.

8. The method of claim 7, wherein the displacement value is based on an instruction pointer (IP) and an offset corresponding to the first relative indirect call.

9. The method of claim 8, wherein the displacement value is a sum of the IP and the offset corresponding to the first relative indirect call.

10. The method of claim 7, further comprising clearing branch address pipeline circuitry in response to replacing the branch prediction target with the common indirect addressing target.

11. The method of claim 10, wherein the branch prediction target is inaccurate.

12. The method of claim 11, wherein clearing the branch address pipeline circuitry prevents clearing jump execution pipeline circuitry.

13. The method of claim 7, further comprising loading the common indirect addressing target from a system memory for the first relative indirect call.

14. The method of claim 13, further comprising reading the common indirect addressing target from the cache entry for the second relative indirect call instead of loading the common indirect addressing target from the system memory.

15. A system comprising:
a system memory;
address calculation circuitry to calculate a displacement value corresponding to a first relative indirect call;
a cache to store an entry corresponding to the first relative indirect call, the entry to include the displacement value and a common indirect addressing target; and
branch prediction circuitry to provide a branch prediction target for a second relative indirect call, wherein the branch prediction target is to be replaced with the common indirect addressing target.

16. The system of claim 15, wherein the common indirect addressing target is to be loaded from the system memory for the first relative indirect call.

17. The system of claim 16, wherein the common indirect addressing target is to be read from the entry for the second relative indirect call instead of loaded from the system memory.

18. The system of claim 15, wherein the displacement value is based on an instruction pointer (IP) and an offset corresponding to the first relative indirect call.

19. The system of claim 15, wherein use of the common indirect addressing target results in clearing branch address pipeline circuitry.

20. The system of claim 19, wherein use of the common indirect addressing target results in clearing branch address pipeline circuitry instead of clearing jump execution pipeline circuitry.
